(19) United States
(12) Patent Application Publication
(10) Pub. No.: US 2013/0127858 A1
(43) Pub. Date: May 23, 2013

(54) Interception of Graphics API Calls for Optimization of Rendering

(71) Applicants: Luc Leroy, Los Gatos, CA (US); Antoine Amanieux, New York, NY (US)

(72) Inventors: Luc Leroy, Los Gatos, CA (US); Antoine Amanieux, New York, NY (US)

(21) Appl. No.: 12/474,944

(22) Filed: May 29, 2009

(51) Int. Cl. G06T 15/60

(52) U.S. Cl. 345/426

(57) ABSTRACT

A method, system, and computer-readable storage medium are disclosed for graphics application programming interface (API) interception. In one embodiment, one or more function calls to a graphics API may be received. The function calls may comprise one or more parameters usable to render a scene. The scene's geometry comprising one or more objects may be generated based on the one or more parameters. One or more graphics programming unit (GPU) shaders may be generated based on the one or more parameters. Each of the GPU shaders may comprise instructions for rendering a corresponding one or more of the objects based on the one or more parameters. The geometry and the GPU shader(s) may be sent to a GPU. In one embodiment, the execution of the GPU shader(s) on the GPU may be caused to render the scene comprising the one or more objects.

### BACKGROUND

### Description of Related Art

Graphics operations are often performed using dedicated graphics rendering devices referred to as graphics processing units (GPUs). As used herein, the terms “graphics processing unit” and “graphics processor” are used interchangeably. GPUs are often used in removable graphics cards that are coupled to a motherboard via a standardized bus (e.g., AGP or PCI Express). GPUs may also be used in game consoles and in integrated graphics solutions (e.g., for use in some portable computers and lower-cost desktop computers). Although GPUs vary in their capabilities, they may typically be used to perform such tasks as rendering of two-dimensional (2D) graphical data, rendering of three-dimensional (3D) graphical data, accelerated rendering of graphical user interface (GUI) display elements, and digital video playback. A GPU may implement one or more application programmer interfaces (APIs) that permit programmers to invoke the functionality of the GPU.

To reduce demands on central processing units (CPUs) of computer systems, GPUs may be tasked with performing operations that would otherwise contribute to the CPU load. Accordingly, modern GPUs are typically implemented with specialized features for efficient performance of common graphics operations. For example, a GPU often includes a plurality of execution channels that can be used simultaneously for highly parallel processing. A GPU may include various built-in and configurable structures for rendering digital images to an imaging device.

Digital image editing is the process of creating and/or modifying digital images using a computer system. Using specialized software programs, users may manipulate and transform images in a variety of ways. These digital image editors may include programs of differing complexity such as limited-purpose programs associated with acquisition devices (e.g., digital cameras and scanners with bundled or built-in programs for managing brightness and contrast); limited editors suitable for relatively simple operations such as rotating and cropping images; and professional-grade programs with large and complex feature sets.

Digital images may include raster graphics, vector graphics, or a combination thereof. Raster graphics data (also referred to herein as bitmaps) may be stored and manipulated as a grid of individual picture elements called pixels. A bitmap may be characterized by its width and height in pixels and also by the number of bits per pixel. Commonly, a color bitmap defined in the RGB (red, green blue) color space may comprise between one and eight bits per pixel for each of the red, green, and blue channels. An alpha channel may be used to store additional data such as per-pixel transparency values. Vector graphics data may be stored and manipulated as one or more geometric objects built with geometric primitives. The geometric primitives (e.g., points, lines, paths, polygons, Bezier curves, and text characters) may be based upon mathematical equations to represent parts of vector graphics data in digital images. The geometric objects may typically be located in two-dimensional or three-dimensional space. A three-dimensional object may be represented in two-dimensional space for the purposes of displaying or editing the object.

### SUMMARY

Various embodiments of systems, methods, and computer-readable storage media for graphics application programming interface (API) interception are disclosed. In one embodiment, one or more function calls to a graphics API may be received. The function calls may comprise one or more parameters usable to render a scene. The scene's geometry comprising one or more objects may be generated based on the one or more parameters. One or more graphics programming unit (GPU) shaders may be generated based on the one or more parameters. Each of the GPU shaders may comprise instructions for rendering a corresponding one or more of the objects based on the one or more parameters. The geometry and the GPU shader(s) may be sent to a GPU. In one embodiment, the execution of the GPU shader(s) on the GPU may be caused to render the scene comprising the one or more objects.

In one embodiment, the geometry may be stored in a memory of the GPU. An additional one or more function calls to the graphics API may be received. The additional one or more function calls may comprise an additional one or more parameters usable to render a second scene. A second geometry of the second scene may be generated based on the additional one or more parameters. A comparison may be performed to determine if the second geometry differs from the stored geometry. The second geometry may be sent to the GPU only if the second geometry differs from the stored geometry. The second scene may be rendered using the stored geometry if the second geometry does not differ from the stored geometry.

In one embodiment, a first implementation of the graphics API may be replaced with a second implementation of the graphics API. The function call to the graphics API may be received using the second implementation of the graphics API instead of the first implementation. In one embodiment, the one or more shaders may be sent to the GPU using a second graphics API.

In various embodiments, the shaders may comprise vertex shaders and/or pixel shaders. In various embodiments, generating the one or more shaders may comprise selecting a stored shader and/or compiling a shader.

### BRIEF DESCRIPTION OF THE DRAWINGS

FIG. 1 is a block diagram illustrating an embodiment of a graphics API interception system.

FIG. 2 is a block diagram illustrating one embodiment of a graphics processing unit (GPU) configured for use with the systems, methods, and media for graphics API interception for optimization of rendering.

FIG. 3 is a flowchart illustrating a method for graphics API interception according to one embodiment.

FIG. 4 is a flowchart illustrating a method for graphics API interception according to one embodiment.

FIG. 5 is a block diagram illustrating constituent elements of a computer system that is configured to implement embodiments of the system, methods, and media for graphics API interception for optimization of rendering.

FIG. 6 is a block diagram illustrating an apparatus that is configured to provide graphics API interception for optimization of rendering according to one embodiment.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Using embodiments of the systems, methods, and media described herein, a function call to a graphics application programming interface (API) may be intercepted, and the desired operation may instead be performed using optimized instructions. In one embodiment, the optimized instructions may be executed using a graphics processing unit (GPU). An original implementation of the graphics API may be bypassed.

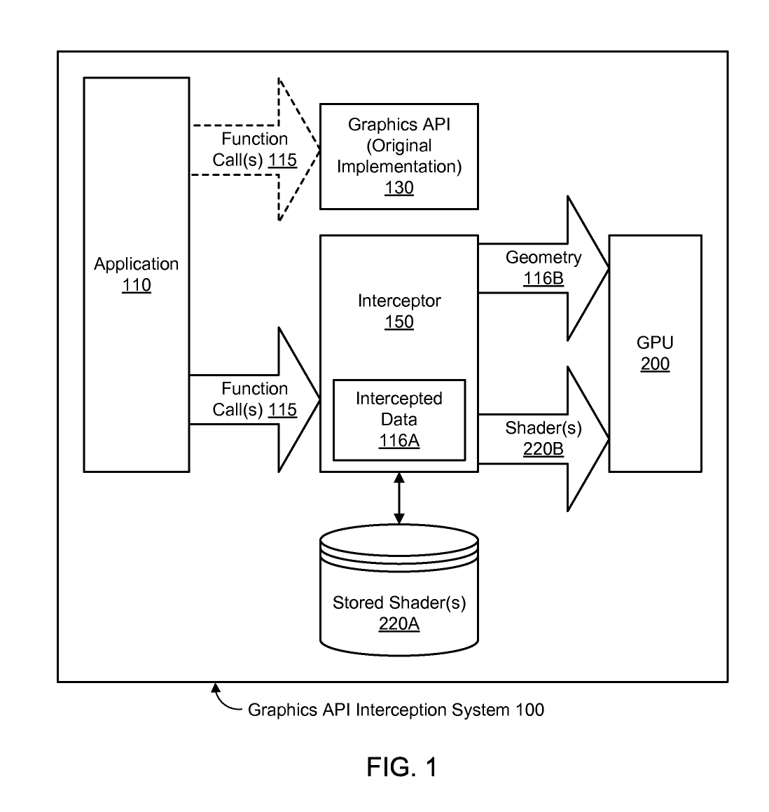

FIG. 1 is a block diagram illustrating an embodiment of a graphics API interception system 100. In one embodiment, an interceptor 150 may intercept one or more function calls 115 intended for a graphics API 130. One or more graphics APIs may permit programs to invoke graphics functionality such as the functionality of a GPU 200. In some embodiments, a graphics API may comprise a version of OpenGL®, DirectX® (including Direct3D®), and/or another suitable API. A particular graphics API 130 may be implemented in accordance with a standard specification. The standard specification may define a plurality of graphics functions and the behaviors expected of each function. By creating a library of functions to match the functions defined in the specification, an implementation of a graphics API 130 may be created for any suitable computing platform. For example, a graphics API 130 may be implemented by a driver for a suitable graphics card or built-in graphics element that includes the GPU 200. As used herein, the graphics API 130 may also be referred to as an original implementation of the graphics API.

The original implementation of the graphics API 130 may comprise a plurality of functions which, when invoked, may be used to perform a variety of graphics operations. For example, one or more function calls to the graphics API 130 may be invoked to draw a complex 2D or 3D scene based on graphics primitives (e.g., lists of vertex positions in 2D or 3D space, color values associated with the vertices, etc.). A program 110 may invoke a particular function of the graphics API 130 by making one or more function calls 115 in accordance with the specification for the API. In making the function call(s) 115, the invoking program 110 may pass any suitable parameters (e.g., graphics data) usable to perform the desired graphics operation. For example, a function supplied by the graphics API 130 may accept graphics primitives such as points (e.g., a single vertex), lines (e.g., two vertices), polygons (e.g., three or more vertices), and other suitable geometric data. Additional parameters may comprise textures, colors, and other material and lighting values for one or more graphical objects.

The program 110 may also be referred to herein as an application 110. However, the program 110 may comprise any component or set of instructions that seeks to perform graphics operations using the graphics API 130. For example, the program 110 may comprise a component of an operating system, such a component responsible for generating visual elements of a graphical user interface (GUI). The program 110 may comprise a suitable application program such as an image editor, a CAD (computer-aided design) application, a video game, or a scientific visualization application.

In one embodiment, the interceptor 150 may comprise a programmable interface that is compatible with the interface specified for the graphics API 130. The interceptor 150 may comprise a graphics API and a library of function calls similar to that of the graphics API 130. In one embodiment, each of the function calls 115 supported by the graphics API 130 may correspond to a function call having the same name and the same parameters as supported by the interceptor 150. In one embodiment, a suitable product such as Adobe Acrobat® or Adobe Acrobat® Pro Extended (available from Adobe Systems, Inc.), or a variation thereof, may comprise the interceptor 150. In one embodiment, the interceptor 150 may comprise a driver or virtual driver for the graphics API 130.

The portion of the original implementation of the graphics API 130 that is responsible for handling the function call(s) 115 may not be invoked after the interception of the function call(s) 115. In one embodiment, the original implementation of the graphics API 130 (e.g., an original driver for the GPU 200) may not be present in the graphics API interception system 100. In one embodiment, the interceptor 150 may replace the original implementation of the graphics API 130. Any suitable technique for intercepting function calls, such as switching the interceptor 150 with the original implementation of the graphics API 130, may be used. For example, the filename of the original implementation of the graphics API 130 may be modified, and the interceptor 150 may be given the original filename of the original implementation of the graphics API 130. In one embodiment, the interceptor 150 may replace the original implementation of the graphics API 130 only for a selected set of programs such as the application 110. For example, the interceptor 150 may be given the original filename of the original implementation of the graphics API 130 and placed in a directory associated with the application 110; the original implementation of the graphics API 130 may continue to be used by other programs.

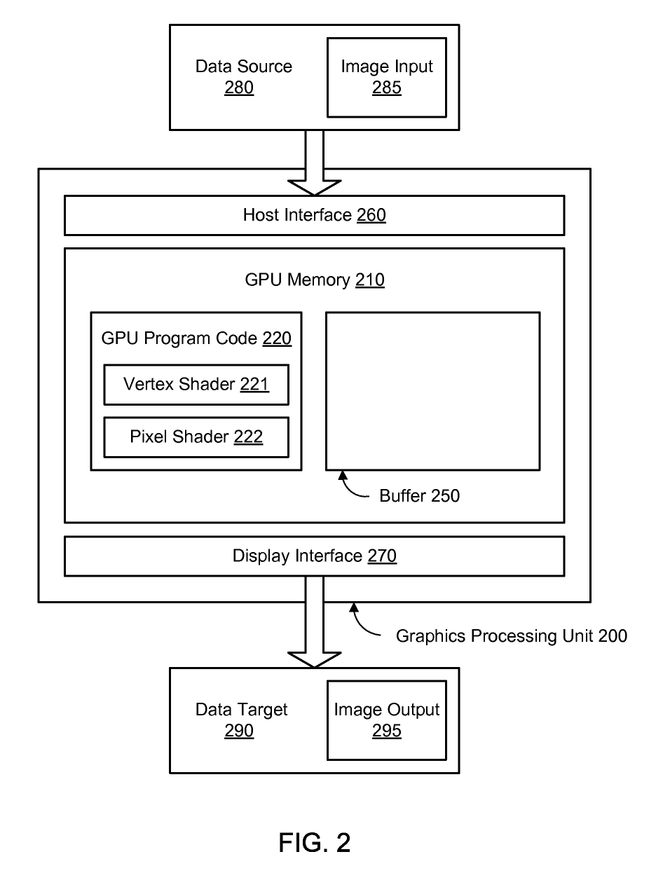

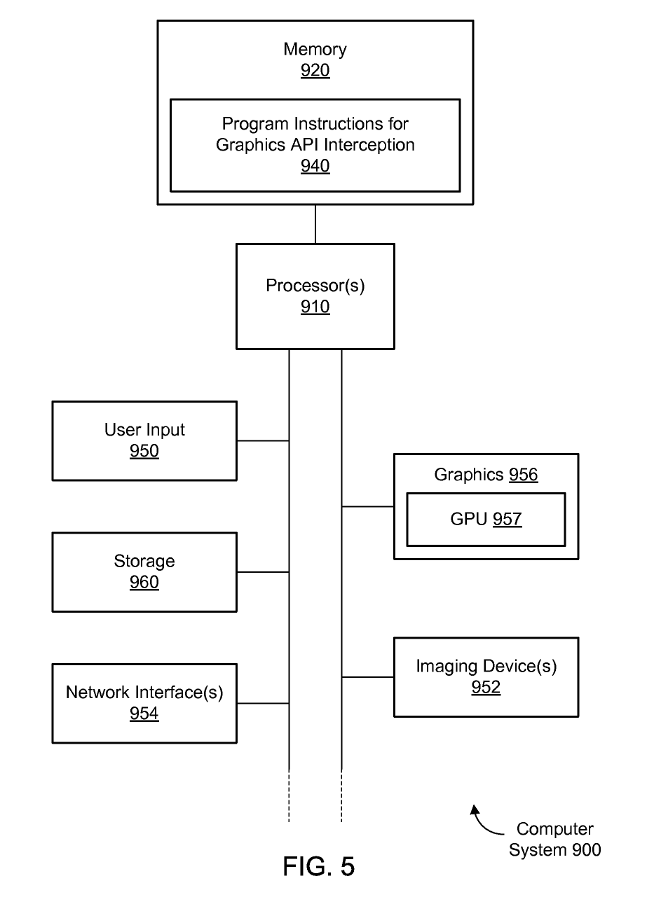

FIG. 2 is a block diagram illustrating one embodiment of a GPU 200 configured for use with the systems, methods, and media for graphics API interception. The GPU 200, also referred to herein as a graphics processor, may comprise a dedicated graphics rendering device associated with a computer system. An example of a suitable computer system 900 for use with a GPU is illustrated in FIG. 5. Turning back to FIG. 2, the GPU 200 may include numerous specialized components configured to optimize the speed of rendering graphics output. For example, the GPU 200 may include specialized components for rendering three-dimensional models, for applying textures to surfaces, etc. For the sake of illustration, however, only a limited selection of components is shown in the example GPU 200 of FIG. 2. It is contemplated that GPU architectures other than the example architecture of FIG. 2 may be usable for implementing the techniques described herein. Suitable GPUs may be commercially available from vendors such as NVIDIA Corporation, ATI Technologies, and others.

The GPU 200 may include a host interface 260 configured to communicate with a data source 280 (e.g., a communications bus and/or processor(s) 910 of a host computer system 200). For example, the data source 280 may provide image input data 285 and/or executable program code to the GPU 200. In some embodiments, the host interface 260 may permit the movement of data in both directions between the GPU 200 and the data source 280. The GPU 200 may also include a display interface 270 for providing output data to a data target 290. The data target 290 may comprise an imaging device 952 such as a display or printer. For example, if data target 290 comprises a display device 952, the GPU 200 (along with other graphics components and/or interfaces 956) may “drive” the display 952 by providing graphics data at a particular rate from a screen buffer (e.g., the buffer 250).

In one embodiment, the GPU 200 may include internal memory 210. The GPU memory 210, also referred to herein as “video memory” or “VRAM,” may comprise random-access memory (RAM) which is accessible to other GPU components. As will be described in greater detail below, the GPU memory 210 may be used in some embodiments to store various types of data and instructions such as input data, output data, intermediate data, program instructions for performing various tasks, etc. In one embodiment, the GPU 200 may also be configured to access a memory 920 of a host computer system 900 via the host interface 260.

In one embodiment, the GPU 200 may include GPU program code 220 that is executable by the GPU 200 to perform aspects of techniques discussed herein. Elements of the image input 285 may be rasterized to pixels during a rendering process including execution of the GPU program code 220 on the GPU 200. Elements of the GPU program code 220 may be provided to the GPU 200 by a host computer system (e.g., the data source 280) and/or may be native to the GPU 200. The GPU program code 220 may comprise a vertex shader 221 and/or a pixel shader 222. A vertex shader 221 may comprise program instructions that are executable by the GPU 200 to determine the properties (e.g., the position) of a particular vertex. In one embodiment, a vertex shader 221 may expect input such as uniform variables (e.g., constant values for each invocation of the vertex shader) and vertex attributes (e.g., per-vertex data). A pixel shader 222 may comprise program instructions that are executable by the GPU 200 to determine properties (e.g., color) of a particular pixel. A pixel shader 222 may also be referred to as a fragment shader. A pixel shader 222 may expect input such as uniform variables (e.g., constant values for each invocation of the pixel shader) and pixel attributes (e.g., per-pixel data). In generating the image output 295, the vertex shader 221 and/or the pixel shader 222 may be executed at various points in the graphics pipeline.

The GPU memory 200 may comprise one or more buffers 250. Each buffer 250 may comprise a two-dimensional array of pixel data (e.g., color values) and/or pixel metadata (e.g., depth values, stencil values, etc.). For example, the GPU memory 210 may comprise an image buffer 250 that stores intermediate or final pixel values generated in the rendering process. In one embodiment, the image buffer 250 may comprise a single-sampling buffer wherein each pixel in the buffer is represented by a single set of color and alpha values (e.g., one color value for a red channel, one color value for a green channel, one color value for a blue channel, and appropriate values for a one or more alpha channels). In one embodiment, the image buffer 250 may comprise a multi-sampling buffer usable for anti-aliasing.

In one embodiment, the GPU 200 may have two rendering modes. The first rendering mode may comprise a transform and lighting mode. In the transform and lighting (“TnL”) mode, the image input 285 may comprise graphics primitives (e.g., vertices) along with texture and lighting data. The transform and lighting mode may typically be the slower of the two modes due to numerous tests and calculations performed on each vertex. The second rendering mode may comprise a vertex shading mode. In the vertex shading mode, the image input 285 may comprise the geometry 116B (e.g., a plurality of vertices) shown in FIG. 1. One or more shaders 220 such as a vertex shader 221 and/or a pixel shader 222 may then be executed for the geometry 116B to render the scene. The vertex shading mode may typically be faster than the transform and lighting mode. Using the systems, methods, and media described herein, one or more function calls 115 to a graphics API 130 may be intercepted to optimize the rendering of a scene using the vertex shading mode of the GPU 200.

Turning back to FIG. 1, in one embodiment, the interceptor 150 may store in memory the data (i.e., the intercepted data 116A) associated with the one or more function calls 115. The intercepted data 116A may comprise any suitable parameters (e.g., graphics data) passed with the function call(s) 115. For example, one or more of the function calls 115 to the graphics API 130 may be accompanied by graphics primitives such as points (e.g., a single vertex), lines (e.g., two vertices), polygons (e.g., three or more vertices), and other suitable geometric data. The geometric data may be extracted from each function call as the function call is intercepted by the interceptor 150. The interceptor 150 may use the intercepted data 116A to construct geometry 116B representing the graphics primitives and/or other data associated with the function call(s) 115. The geometry 116B may comprise one or more objects. The identity and/or order of the function calls 115 may be used to determine the hierarchy of the objects in the geometry 116B. In one embodiment, an object may comprise a list of triangles assigned to one material and one lighting scheme. Each triangle may comprise an index of vertices stored in a vertex buffer.

In one embodiment, the geometry 116B may be sent to the GPU 200 (e.g., as image input 285) at an appropriate point in time; before that point, the objects in the geometry 116B may be held in a system memory accessible to the interceptor 150. For example, the geometry 116B may be held in memory until the interceptor 150 receives a function call indicating that the entire scene (representing the geometry associated with the previous function calls) is to be drawn. In an embodiment using OpenGL® as the graphics API 130, a function call such as glFlush or glDrawArray may indicate to the interceptor 150 that the scene should be rendered. When such a function call is received, the geometry 116B may be sent to the GPU 200 for rendering the scene including the geometry. The scene may also be referred to herein as a frame.

The geometry 116B sent as the image input 285 may be stored in the GPU memory 210 (e.g., as a vertex buffer). In one embodiment, the geometry 116B for a subsequent frame may be sent to the GPU 200 (e.g., as a vertex buffer) only if the geometry 116 has changed in comparison to the geometry in the previously rendered frame. Any suitable technique may used to determine whether the geometry 116B has changed and thus should be updated in the GPU memory 210. For example, a checksum may be generated for the geometry or for elements of the geometry, and the checksums may be compared (e.g., from frame to frame) to determine if the geometry should be updated in the GPU memory 210. A “dirty” flag may be associated with the geometry or with elements of the geometry to indicate the need to update the geometry in the GPU memory 210. A change in the geometry 116B may comprise a change in the coordinates of any point (e.g., the position, optional normal, and/or optional mapping coordinate).

The interceptor 150 may generate instructions for implementing the invoked function(s) on the GPU 200 to render the scene including the geometry 116B. After generating the instructions, the interceptor 150 or other suitable component of the graphics API interception system 100 may cause the GPU 200 to perform the requested operation(s) (e.g., render the scene) using the generated instructions. In one embodiment, the generated instructions may comprise one or more shaders 220B which are executable on the GPU 200. A shader, also referred to herein as a GPU shader, may comprise one or more program instructions that are executable on a programmable GPU (e.g., in the vertex shader rendering mode). In various embodiments, each shader 220B may comprise a vertex shader 221 or a pixel shader 222. In one embodiment, a shader may be generated for each object in the geometry 116B. The shader generated for one object may differ from the shader generated for another object. In one embodiment, the interceptor 150 may generate a suitable shader for each object based on the parameters in the function call(s) 115.

In one embodiment, the process of generating the shader(s) 220B may comprise selecting and retrieving an existing shader from a set of stored shaders 220A. For example, for each object in the geometry 116B, the interceptor 150 may select and retrieve one of the set of stored shaders 220A based on any suitable parameters desired for rendering the object, such as the lighting scheme and/or rendering mode associated with the object. In one embodiment, for example, a shader comprising the following GPU-executable instructions may be selected for rendering an object with bump mapping and diffuse, specular, and opacity maps:

ps.1.4

texld r0,t0

texcrd r1.rgb, t1; Normalized Tangent Space Light vector

texcrd r2.rgb, t2; Tangent Space Halfangle vector

texld r3,t3; Load diffuse texture use r3 as texture crd index

texld r4,t4; Load specular texture

dp3 r5.xyz, r1, r0_bx2

dp3 r2, r2, r0_bx2

mov r2.x,r5.x

mul r0,r3, c0

mul r4,r4, c2

phase

texld r2,r2; Load phong lookup texture use r2 as texture crd index

texld r5,t5; Load opacity texture use t5 as texture crd index

mul r1.rgb, r2.a,r2.a

mul r3.rgb,r0,r2; [diffuse texture]*C0*phong

mad r2.rgb, r2,c1,r3

mul r3.rgb, r1,r4

mad r0.rgb, r1,c3,r3

add r0.rgb,r2,r0

mad r0.rgb, r0,v0,c5

mul r0.a,r5.a,c5.a

In one embodiment, the process of generating the shader(s) 220B may comprise compiling one or more of the shaders 220B. In one embodiment, the process of generating the shader(s) 220B may comprise modifying an existing shader or an existing template for a shader. In one embodiment, one or more of the stored shaders 220A may comprise a template for executing a suitable graphics operation using the GPU 200. The interceptor 150 may modify a retrieved shader based on attributes of the function call(s) 115 and/or its parameters (i.e., the intercepted data 116A), thereby generating a modified shader. In one embodiment, the set of stored shaders 220A may be modified by saving a new template or modifying an existing shader based on the modified shader 220B. In one embodiment, a plurality of function calls 115 to the graphics API 130 may be used in a complex graphics operation or set of graphics operations. Therefore, one or more shaders 220B may be generated to implement a plurality of functions associated with a plurality of function calls 115 to the graphics API 130.

The interceptor 150 may send the one or more shaders 220B to the GPU 200. In one embodiment, the one or more shaders 220B may be sent to the GPU 200 when the application 110 requests that the scene be drawn (e.g., by making an appropriate function call using the graphics API 130). The interceptor 150 may request that each of the objects be rendered using the particular shader 220B selected for the object. In one embodiment, the shaders 220B may be sent to the GPU 200 after the geometry 116B is sent to the GPU 200. In one embodiment, the one or more shaders 220B may be sent to the GPU 200 using a different graphics API than the graphics API 130 associated with the function call 115. For example, the graphics API 130 used for the function call(s) 115 may comprise a version of OpenGL®, and the graphics API used to send the shader(s) 220B to the GPU 200 may comprise a version of DirectX® and/or Direct3D®.

The GPU 200 may execute the shader 220B to implement the requested graphics operation(s), e.g., by drawing the scene comprising the geometry 116B. In one embodiment, each of the shaders 220B may be executed for a corresponding one of the objects in the geometry 116B. In one embodiment, one of the shaders 220B may be executed for a plurality of objects in the geometry 116B.

In one embodiment, the original implementation of the graphics API 130 may not utilize shaders to implement the graphics operation(s) associated with the function calls 115. Using the techniques discussed herein, the interceptor 150 may intercept the function calls 115 in a manner that is transparent to the calling application 110. Therefore, the graphics API interception system 100 may take advantage of the performance benefits of a GPU 200 that uses shaders without changing the application 110.

In one embodiment, the interceptor 150 may implement one or more functions of the graphics API by using conventional techniques instead of by generating vertex shaders as discussed above. Therefore, the interceptor 150 may process some function calls by generating (and causing the execution of) vertex shaders while processing other function calls without using vertex shaders.

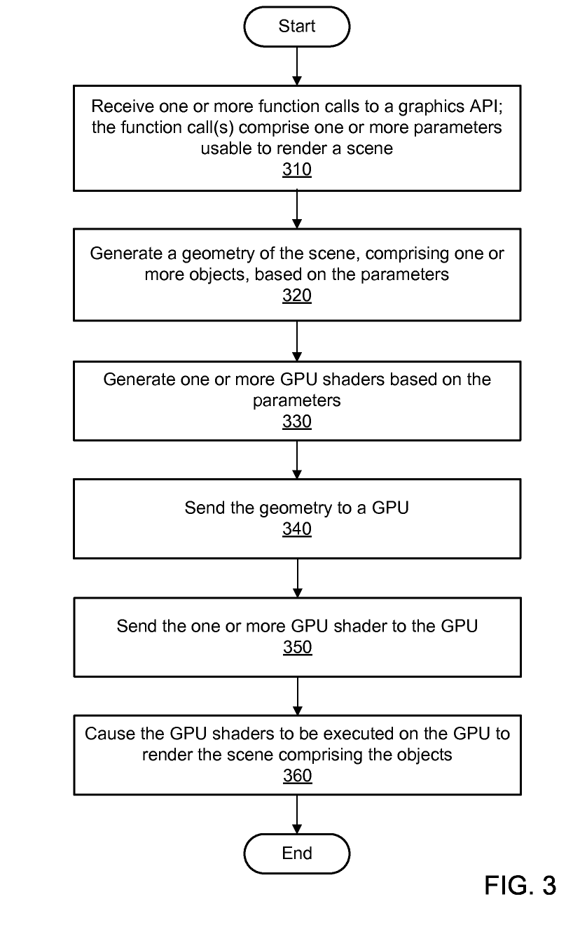

FIG. 3 is a flowchart illustrating a method for graphics API interception according to one embodiment. As shown in 310, one or more function calls to a graphics API may be received. The function calls may comprise one or more parameters usable to render a scene. In one embodiment, the one or more parameters may comprise one or more graphics primitives. In one embodiment, the one or more parameters may comprise a plurality of vertices and one or more lighting attributes associated with the plurality of vertices. As shown in 320, the scene's geometry comprising one or more objects may be generated based on the one or more parameters.

As shown in 330, one or more graphics programming unit (GPU) shaders may be generated based on the one or more parameters. Each of the GPU shaders may comprise instructions for rendering a corresponding one or more of the objects based on the one or more parameters. In various embodiments, the shaders may comprise vertex shaders and/or pixel shaders. In various embodiments, generating the one or more shaders may comprise selecting a stored shader and/or compiling a shader. As shown in 340, the geometry may be sent to a GPU. As shown in 350, the one or more GPU shaders may be sent to the GPU. In one embodiment, the one or more shaders may be sent to the GPU using a second graphics API. As shown in 360, the execution of the GPU shader(s) on the GPU may be caused to render the scene comprising the one or more objects. The result of the execution of the shader(s) may be displayed on a display.

The receiving function used in the operation shown in 310 may be performed by a receiving module implemented by program instructions stored in a computer-readable storage medium and executable by one or more processors (e.g., one or more CPUs or GPUs). The generating function used in the operation shown in 320 may be performed by a generating module implemented by program instructions stored in a computer-readable storage medium and executable by one or more processors (e.g., one or more CPUs or GPUs). The generating function used in the operation shown in 330 may be performed by a generating module implemented by program instructions stored in a computer-readable storage medium and executable by one or more processors (e.g., one or more CPUs or GPUs). The sending function used in the operation shown in 340 may be performed by a sending module implemented by program instructions stored in a computer-readable storage medium and executable by one or more processors (e.g., one or more CPUs or GPUs). The sending function used in the operation shown in 350 may be performed by a sending module implemented by program instructions stored in a computer-readable storage medium and executable by one or more processors (e.g., one or more CPUs or GPUs). The execution-causing function used in the operation shown in 360 may be performed by an execution-causing module implemented by program instructions stored in a computer-readable storage medium and executable by one or more processors (e.g., one or more CPUs or GPUs).

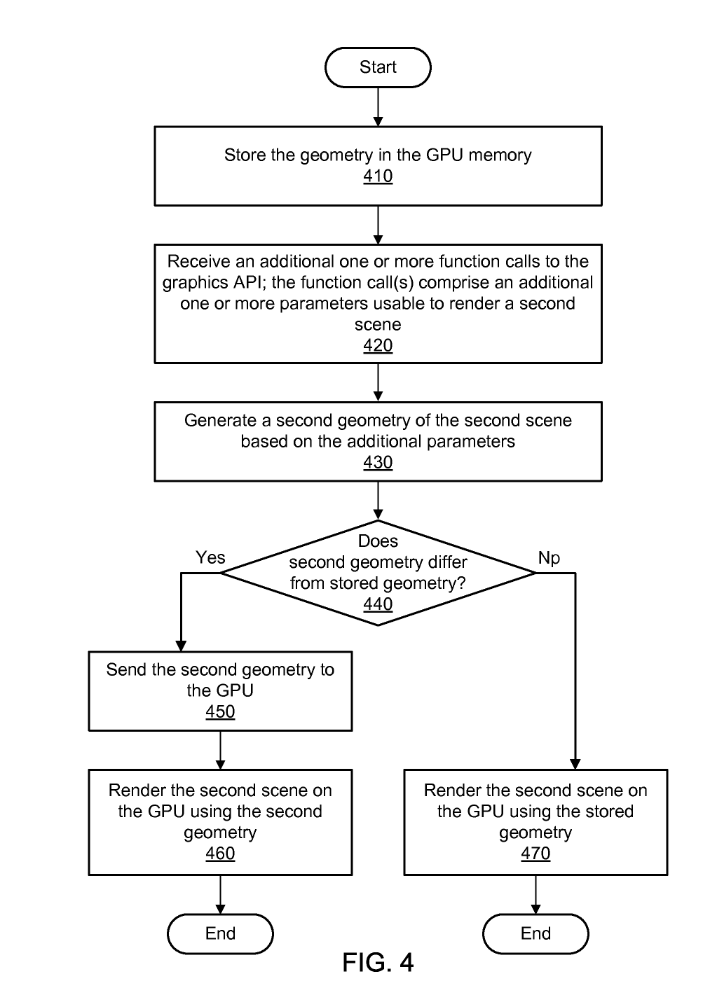

FIG. 4 is a flowchart illustrating further details of a method for graphics API interception according to one embodiment. The operations illustrated in FIG. 4 may be performed after the operations shown in FIG. 3. As shown in 410, the geometry may be stored in a memory of the GPU. As shown in 420, an additional one or more function calls to the graphics API may be received. The additional one or more function calls may comprise an additional one or more parameters usable to render a second scene. As shown in 430, a second geometry of the second scene may be generated based on the additional one or more parameters. As shown in 440, a comparison may be performed to determine if the second geometry differs from the stored geometry. As shown in 450, the second geometry may be sent to the GPU only if the second geometry differs from the stored geometry. One or more shaders may also be sent to the GPU; the shaders may be updated if, for example, the material and/or lighting parameters for the objects have changed. As shown in 460, the second scene may be rendered using the second geometry. As shown in 470, the second scene may be rendered using the stored geometry if the second geometry does not differ from the stored geometry.

In various embodiments, the elements shown in FIGS. 3 and 4 may be performed in a different order than the illustrated order. In FIGS. 3 and 4, any of the operations described in the elements may be performed programmatically (i.e., by a computer according to a computer program). In FIGS. 3 and 4, any of the operations described in the elements may be performed automatically (i.e., without user intervention).

FIG. 5 is a block diagram illustrating constituent elements of a computer system 900 that is configured to implement embodiments of the system, methods, and media for graphics API interception for optimization of rendering. The computer system 900 may include one or more processors 910 implemented using any desired architecture or chip set, such as the SPARC™ architecture, an x86-compatible architecture from Intel Corporation or Advanced Micro Devices, or an other architecture or chipset capable of processing data. Any desired operating system(s) may be run on the computer system 900, such as various versions of Unix, Linux, Windows® from Microsoft Corporation, MacOS® from Apple Inc., or any other operating system that enables the operation of software on a hardware platform. The processor(s) 910 may be coupled to one or more of the other illustrated components, such as a memory 920, by at least one communications bus.

In one embodiment, a specialized graphics card or other graphics component 956 may be coupled to the processor(s) 910. The graphics component 956 may include a graphics processing unit (GPU) 957. Additionally, the computer system 900 may include one or more imaging devices 952. The one or more imaging devices 952 may include various types of raster-based imaging devices such as monitors and printers. In one embodiment, one or more display devices 952 may be coupled to the graphics component 956 for display of data provided by the graphics component 956.

In one embodiment, program instructions 940 that may be executable by the processor(s) 910 to implement aspects of the techniques described herein may be partly or fully resident within the memory 920 at the computer system 900 at any point in time. For example, program instructions for graphics API interception 940, including all or part of the interceptor 150 and its related elements and data, may be stored in the memory 920. The memory 920 may be implemented using any appropriate medium such as any of various types of ROM or RAM (e.g., DRAM, SDRAM, RDRAM, SRAM, etc.), or combinations thereof. The program instructions may also be stored on a storage device 960 accessible from the processor(s) 910. Any of a variety of storage devices 960 may be used to store the program instructions 940 in different embodiments, including any desired type of persistent and/or volatile storage devices, such as individual disks, disk arrays, optical devices (e.g., CD-ROMs, CD-RW drives, DVD-ROMs, DVD-RW drives), flash memory devices, various types of RAM, holographic storage, etc. The storage 960 may be coupled to the processor(s) 910 through one or more storage or I/O interfaces. In some embodiments, the program instructions 940 may be provided to the computer system 900 via any suitable computer-readable storage medium including the memory 920 and storage devices 960 described above.

The computer system 900 may also include one or more additional I/O interfaces, such as interfaces for one or more user input devices 950. In addition, the computer system 900 may include one or more network interfaces 954 providing access to a network. It should be noted that one or more components of the computer system 900 may be located remotely and accessed via the network. The program instructions may be implemented in various embodiments using any desired programming language, scripting language, or combination of programming languages and/or scripting languages, e.g., C, C++, C#, Java™, Perl, etc. The computer system 900 may also include numerous elements not shown in FIG. 5, as illustrated by the ellipsis.

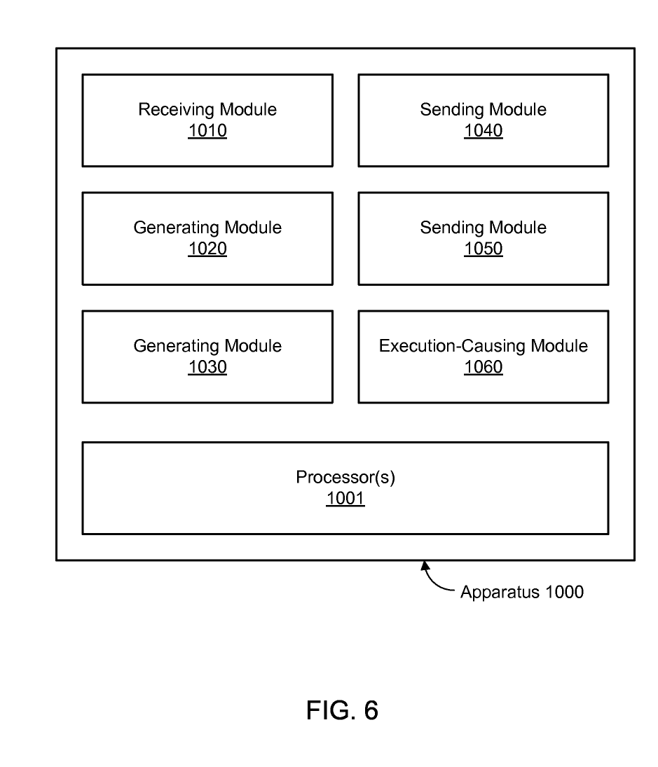

FIG. 6 is a block diagram illustrating an apparatus 1000 that is configured to provide graphics API interception for optimization of rendering according to one embodiment. The apparatus may comprise a plurality of modules such as modules 1010, 1020, 1030, 1040, 1050, and 1060. Each of the modules 1010, 1020, 1030, 1040, 1050, and 1060 may comprise a computer-readable storage medium such as the storage media discussed with reference to FIG. 5. Each of the modules 1010, 1020, 1030, 1040, 1050, and 1060 may comprise program instructions that are executable by at least one processor 1001.

In one embodiment, the receiving module 1010 may perform the receiving function in the operation shown in 310 of FIG. 3. For example, the processor(s) 1001 may create the receiving module 1010 and/or execute program instructions in the receiving module 1010 to perform the receiving function in the operation shown in 310. In one embodiment, the generating module 1020 may perform the generating function in the operation shown in 320 of FIG. 3. For example, the processor(s) 1001 may create the generating module 1020 and/or execute program instructions in the generating module 1020 to perform the receiving function in the operation shown in 320. In one embodiment, the generating module may perform the generating function 1030 in the operation shown in 330 of FIG. 3. For example, the processor(s) 1001 may create the generating module 1030 and/or execute program instructions in the generating module 1030 to perform the receiving function in the operation shown in 330. In one embodiment, the sending module 1040 may perform the sending function in the operation shown in 340 of FIG. 3. For example, the processor(s) 1001 may create the sending module 1040 and/or execute program instructions in the sending module 1040 to perform the receiving function in the operation shown in 340. In one embodiment, the sending module 1050 may perform the sending function in the operation shown in 350 of FIG. 3. For example, the processor(s) 1001 may create the sending module 1050 and/or execute program instructions in the sending module 1050 to perform the receiving function in the operation shown in 350. In one embodiment, the execution-causing module 1060 may perform the execution-causing function in the operation shown in 360 of FIG. 3. For example, the processor 1001(s) may create the execution-causing module 1060 and/or execute program instructions in the execution-causing module 1060 to perform the receiving function in the operation shown in 360.

Although the embodiments above have been described in detail, numerous variations and modifications will become apparent to those skilled in the art once the above disclosure is fully appreciated. It is intended that the following claims be interpreted to embrace all such variations and modifications.

1. A computer-implemented method, comprising:
receiving one or more function calls to a graphics application programming interface (API), wherein the one or more function calls comprise a plurality of parameters usable to render a scene, wherein the plurality of parameters comprise one or more geometric primitives and one or more object attributes;
generating a geometry of the scene based on the plurality of parameters, wherein the geometry comprises one or more objects generated dependent on the one or more geometric primitives;
generating one or more graphics processing unit (GPU) shaders based on the plurality of parameters, wherein each of the one or more GPU shaders comprises instructions for rendering a corresponding one or more of the objects based on the plurality of parameters, and wherein generating the one or more GPU shaders comprises, for each of the one or more objects, selecting a respective GPU shader dependent on at least one of the object attributes associated with the respective object;
sending the geometry to a GPU;
sending the one or more GPU shaders to the GPU; and
causing an execution of the one or more GPU shaders on the GPU to render the scene comprising the one or more objects.

2. The method as recited in claim 1, wherein selecting the respective GPU shader dependent on at least one of the object attributes associated with the respective object comprises:
selecting a stored GPU shader from a pool of stored GPU shaders dependent on the at least one of the object attributes associated with the respective object.

3. The method as recited in claim 1, wherein selecting the respective GPU shader dependent on at least one of the object attributes associated with the respective object comprises:
selecting a stored GPU shader template;
modifying the selected GPU shader template dependent on the at least one of the object attributes associated with the respective object; and
compiling the modified GPU shader template.

4. (canceled)

5. The method as recited in claim 1, wherein the plurality of parameters comprise a plurality of vertices and one or more lighting attributes associated with the plurality of vertices.

6. The method as recited in claim 1, further comprising:
replacing a first implementation of the graphics API with a second implementation of the graphics API prior to receiving the one or more function calls to the graphics API, wherein the one or more function calls to the graphics API are received using the second implementation of the graphics API.

7. The method as recited in claim 1, wherein the one or more GPU shaders comprise one or more vertex shaders.

8. The method as recited in claim 1, wherein the one or more GPU shaders comprise one or more pixel shaders.

9. The method as recited in claim 1, further comprising:
displaying a result of the execution of the one or more GPU shaders on a display.

10. The method as recited in claim 1, further comprising:
storing the geometry in a memory of the GPU;
receiving an additional one or more function calls to the graphics API, wherein the additional one or more function calls comprise an additional one or more parameters usable to render a second scene;
generating a second geometry of the second scene based on the additional one or more parameters;
determining if the second geometry differs from the stored geometry;
sending the second geometry to the GPU if the second geometry differs from the stored geometry;
rendering the second scene using the second geometry if the second geometry differs from the stored geometry; and
rendering the second scene using the stored geometry if the second geometry does not differ from the stored geometry.

11. The method as recited in claim 1, wherein the one or more GPU shaders are sent to the GPU using a second graphics API.

12. A system, comprising:
one or more processors; and
a graphics processing unit (GPU); and
a memory coupled to the one or more processors and storing program instructions executable by the one or more processors to implement:
receiving one or more function calls to a graphics application programming interface (API), wherein the one or more function calls comprise a plurality of parameters usable to render a scene, wherein the plurality of parameters comprise one or more geometric primitives and one or more object attributes;
generating a geometry of the scene based on the plurality of parameters, wherein the geometry comprises one or more objects generated dependent on the one or more geometric primitives;
generating one or more GPU shaders based on the plurality of parameters, wherein each of the one or more GPU shaders comprises instructions for rendering a corresponding one or more of the objects based on the plurality of parameters, and wherein generating the one or more GPU shaders comprises, for each of the one or more objects, selecting a respective GPU shader dependent on at least one of the object attributes associated with the respective object;
sending the geometry to the GPU; and
sending the one or more GPU shaders to the GPU;
wherein the one or more GPU shaders are executable by the GPU to render the scene comprising the one or more objects.

13. The system as recited in claim 12, wherein, in selecting the respective GPU shader dependent on at least one of the object attributes associated with the respective object, the program instructions are further executable by the one or more processors to implement:
selecting a stored GPU shader from a pool of stored GPU shaders dependent on the at least one of the object attributes associated with the respective object.

14. The system as recited in claim 12, wherein, in selecting the respective GPU shader dependent on at least one of the object attributes associated with the respective object, the program instructions are further executable by the one or more processors to implement:
selecting a stored GPU shader template;
modifying the selected GPU shader template dependent on the at least one of the object attributes associated with the respective object; and
compiling the modified GPU shader template.

15. The system as recited in claim 12, wherein the one or more GPU shaders comprise one or more vertex shaders.

16. The system as recited in claim 12, wherein the one or more GPU shaders comprise one or more pixel shaders.

17. The system as recited in claim 12, wherein the geometry is stored in a memory of the GPU, and wherein the program instructions are further executable by the one or more processors to implement:
receiving an additional one or more function calls to the graphics API, wherein the additional one or more function calls comprise an additional one or more parameters usable to render a second scene;
generating a second geometry of the second scene based on the additional one or more parameters;
determining if the second geometry differs from the stored geometry; and
sending the second geometry to the GPU if the second geometry differs from the stored geometry;
wherein the second scene is rendered by the GPU using the second geometry if the second geometry differs from the stored geometry;
wherein the second scene is rendered by the GPU using the stored geometry if the second geometry does not differ from the stored geometry.

18. The system as recited in claim 12, wherein the one or more GPU shaders are sent to the GPU using a second graphics API.

19. A computer-readable storage medium, storing program instructions computer-executable to implement:
receiving one or more function calls to a graphics application programming interface (API), wherein the one or more function calls comprise a plurality of parameters usable to render a scene, wherein the plurality of parameters comprise one or more geometric primitives and one or more object attributes;
generating a geometry of the scene based on the plurality of parameters, wherein the geometry comprises one or more objects generated dependent on the one or more geometric primitives;
generating one or more graphics processing unit (GPU) shaders based on the plurality of parameters, wherein each of the one or more GPU shaders comprises instructions for rendering a corresponding one or more of the objects based on the plurality of parameters, and wherein generating the one or more GPU shaders comprises, for each of the one or more objects, selecting a respective GPU shader dependent on at least one of the object attributes associated with the respective object;
sending the geometry to a GPU;
sending the one or more GPU shaders to the GPU; and
causing an execution of the one or more GPU shaders on the GPU to render the scene comprising the one or more objects.

20. The computer-readable storage medium as recited in claim 19, wherein selecting the respective GPU shader dependent on at least one of the object attributes associated with the respective object comprises:
selecting a stored GPU shader from a pool of stored GPU shaders dependent on the at least one of the object attributes associated with the respective object.

21. The computer-readable storage medium as recited in claim 19, wherein selecting the respective GPU shader dependent on at least one of the object attributes associated with the respective object comprises:
selecting a stored GPU shader template;
modifying the selected GPU shader template dependent on the at least one of the object attributes associated with the respective object; and
compiling the modified GPU shader template.

22. The computer-readable storage medium as recited in claim 19, wherein the one or more GPU shaders comprise one or more vertex shaders.

23. The computer-readable storage medium as recited in claim 19, wherein the one or more GPU shaders comprise one or more pixel shaders.

24. The computer-readable storage medium as recited in claim 19, wherein the program instructions are further computer-executable to implement:
storing the geometry in a memory of the GPU;
receiving an additional one or more function calls to the graphics API, wherein the additional one or more function calls comprise an additional one or more parameters usable to render a second scene;
generating a second geometry of the second scene based on the additional one or more parameters;
determining if the second geometry differs from the stored geometry;
sending the second geometry to the GPU if the second geometry differs from the stored geometry;
rendering the second scene using the second geometry if the second geometry differs from the stored geometry; and
rendering the second scene using the stored geometry if the second geometry does not differ from the stored geometry.

25. The computer-readable storage medium as recited in claim 19, wherein the one or more GPU shaders are sent to the GPU using a second graphics API.
